(19) United States
(12) Patent Application Publication
(10) Pub. No.: US 2025/0247475 A1
(43) Pub. Date: Jul. 31, 2025

(54) INFORMATION PROCESSING SYSTEM, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventors: Shogo ISHIKAWA, Kanagawa (JP); Takashi KIKUMOTO, Kanagawa (JP); Yoshie OHIRA, Kanagawa (JP)

(73) Assignee: FUJIFILM Business Innovation Corp., Tokyo (JP)

(21) Appl. No.: 18/817,253

(22) Filed: Aug. 28, 2024

(30) Foreign Application Priority Data
Jan. 30, 2024 (JP) 2024-011666

(51) Int. Cl. H04N 1/00

(52) U.S. Cl. CPC H04N 1/00029

(57) ABSTRACT

An information processing system includes a processor configured to examine whether or not there is an abnormality in a printed material, execute first processing associated with a first abnormality in a case where only the first abnormality is detected from the printed material, execute second processing associated with a second abnormality having a type different from a type of the first abnormality in a case where only the second abnormality is detected from the printed material, and execute third processing in a case where both the first abnormality and the second abnormality are detected from the printed material.

### CROSS-REFERENCE TO RELATED APPLICATIONS

This application is based on and claims priority under 35 USC 119 from Japanese Patent Application No. 2024-011666 filed Jan. 30, 2024.

### BACKGROUND

### (i) Technical Field

The present disclosure relates to an information processing system, a non-transitory computer readable medium storing a program, and an information processing method.

### (ii) Related Art

JP2022-137718A discloses an examination device that can perform appropriate correspondence processing according to a type of a defect of a printed material by examining a defect of a printed material based on a reading result of the printed material that is output as an image by an image forming unit and switching control of the image forming unit according to a type of the detected defect.

### SUMMARY

In some cases, an examination device determines whether or not there is an abnormality by performing an examination on a printed material that is printed by a printing device. In such a case, processing such as printing interruption and reprinting is executed according to a type of the detected abnormality. However, even in a state where processing to be executed for each type of detected abnormality is set, in a case where a plurality of different types of abnormalities are detected from one printed material, it is not possible to determine what type of processing should be executed.

Aspects of non-limiting embodiments of the present disclosure relate to an information processing system, a non-transitory computer readable medium storing a program, and an information processing method that can determine processing for dealing with a detected abnormality in a case where a plurality of different types of abnormalities are detected from one printed material.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a processor configured to examine whether or not there is an abnormality in a printed material, execute first processing associated with a first abnormality in a case where only the first abnormality is detected from the printed material, execute second processing associated with a second abnormality having a type different from a type of the first abnormality in a case where only the second abnormality is detected from the printed material, and execute third processing in a case where both the first abnormality and the second abnormality are detected from the printed material.

### BRIEF DESCRIPTION OF THE DRAWINGS

Exemplary embodiment(s) of the present invention will be described in detail based on the following figures, wherein:

FIG. 1 is a diagram illustrating a system configuration of an image forming system 10 according to an exemplary embodiment of the present disclosure;

FIG. 2 is a diagram for explaining a case where printing of 10 pages is performed on A4-size paper and printing is performed again because a printing defect is detected on a fourth page;

FIG. 3 is a diagram for explaining a type and content of an examination to be performed in an examination device 30;

FIG. 4 is a diagram illustrating an example of an examination target image on which different types of various examinations are to be performed;

FIG. 5 is a diagram for explaining a specific example of error correspondence processing for corresponding to a detected error;

FIG. 6 is a diagram illustrating an example of a setting table indicating a correspondence relationship between an examination type and error correspondence processing;

FIG. 7 is a diagram illustrating a hardware configuration of the image forming system 10 according to the exemplary embodiment of the present disclosure;

FIG. 8 is a block diagram illustrating a functional configuration of the image forming system 10 according to the exemplary embodiment of the present disclosure;

FIG. 9 is a diagram illustrating an example of an operation screen in a case of changing priority setting for setting a priority for each examination type;

FIG. 10 is a diagram illustrating an example of a case where the order of priorities is set between types of examinations by setting the priorities for a plurality of types of examinations;

FIG. 11 is a diagram illustrating a pattern of a method of determining, in a state where the order of the priorities is set, the error correspondence processing in a case where a plurality of different types of examinations are executed on an examination target image as illustrated in FIG. 4;

FIG. 12 is a diagram illustrating an example of a case where regions in which a plurality of errors occur in the examinations overlap with each other;

FIG. 13 is a diagram illustrating another example of a case where regions in which a plurality of errors occur in the examinations overlap with each other;

FIG. 14 is an example of a priority table in which the order of the priorities is set in a case where the regions in which the errors are detected overlap with each other;

FIG. 15 is a flowchart for explaining an operation of the image forming system 10 according to the exemplary embodiment of the present disclosure; and

FIG. 16 is a flowchart for explaining details of processing of step S105 described in the flowchart of FIG. 15.

### DETAILED DESCRIPTION

Hereinafter, an exemplary embodiment of the present disclosure will be described in detail with reference to the drawings.

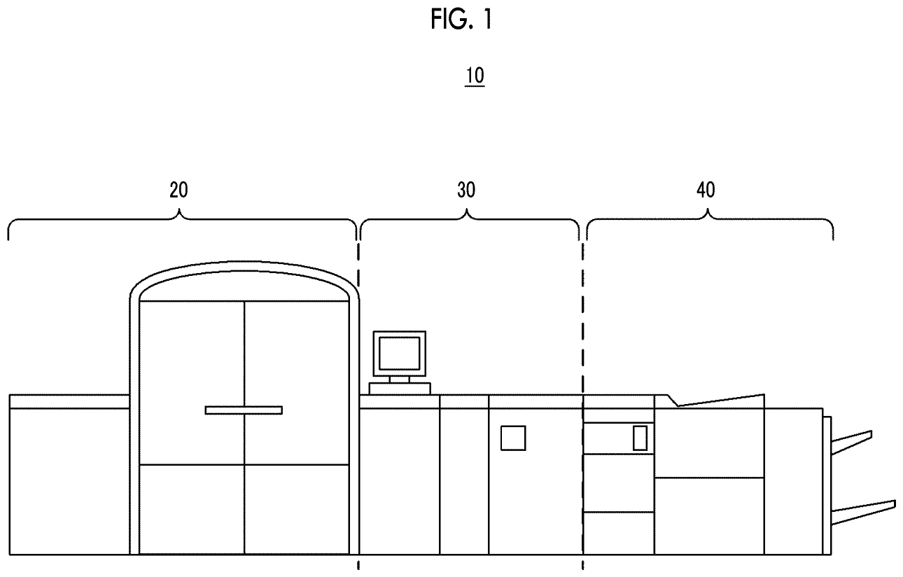

FIG. 1 is a diagram illustrating a system configuration of an image forming system 10 according to an exemplary embodiment of the present disclosure.

As illustrated in FIG. 1, an image forming system 10 according to an exemplary embodiment of the present disclosure includes a printing device 20, an examination device 30, and a post-processing device 40.

The printing device 20 has a function of accommodating paper and executing processing of printing an image on the accommodated paper. In addition, the examination device 30 receives the paper on which the image is printed from the printing device 20, and executes an examination as to whether or not there is an abnormality in the printing result printed on the paper, specifically, an image examination as to whether or not there is a printing stain or the like in the printed image, an examination as to whether or not there is a folded corner, an examination as to whether or not there is an abnormality such as misregistration in the printed image, or the like.

In this image examination, the examination device 30 receives, as a reference image, image data of an image that is printed on the paper from the printing device 20, scans an image that is printed on the paper transported from the printing device 20, collates the received reference image with the scanned image, and examines whether or not there is an abnormality in the image printed on the transported paper.

Further, the post-processing device 40 executes various types of post-processing, such as folding processing, stapling processing, punch hole processing, and booklet production processing, on the paper after the examination is performed by the examination device 30, and discharges the paper to a designated discharge tray. Note that the examination device 30 may perform the examination after the post-processing is executed by the post-processing device 40.

In the image forming system 10, in a case where the examination device 30 detects an abnormality on the paper, processing of switching a discharge destination of the paper on which the abnormality is detected and discharging the paper to a discharge tray different from a normal discharge tray is performed. However, in the processing, in a state where an abnormality is detected on a page during the examination, in a case where only the page is reprinted, the page order is deviated and printed materials of a plurality of consecutive pages are not printed in a correct order.

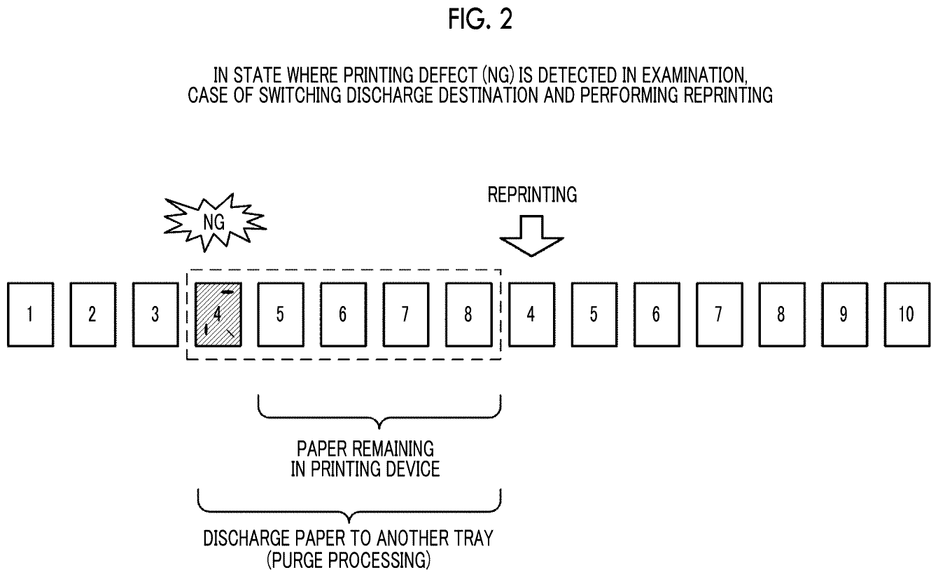

For example, as illustrated in FIG. 2, in a case where printing for 10 pages is performed on sheets of A4-size paper, a case where a fourth page is determined as a page on which a printing defect occurs will be described.

In such a case, since printing for a fifth page to an eighth page, which are subsequent pages, is already performed, it is not enough to reprint only the fourth page that is determined as a page on which a printing defect occurs. In a case where the examination device 30 determines that the fourth page is a page on which a printing defect occurs, printing of the fifth page to the eighth page is already performed in the printing device 20, and the printed pages remain in the printing device 20. Therefore, it is necessary to execute purge processing of switching the discharge destination to a discharge tray for disposal and discharging, as purge pages, five sheets of paper that are the fourth page to the eighth page, to the discharge tray for disposal. In addition, by executing reprinting from the fourth page after the purge processing is executed, it is possible to obtain a printing result in which a page with a printing defect is not included.

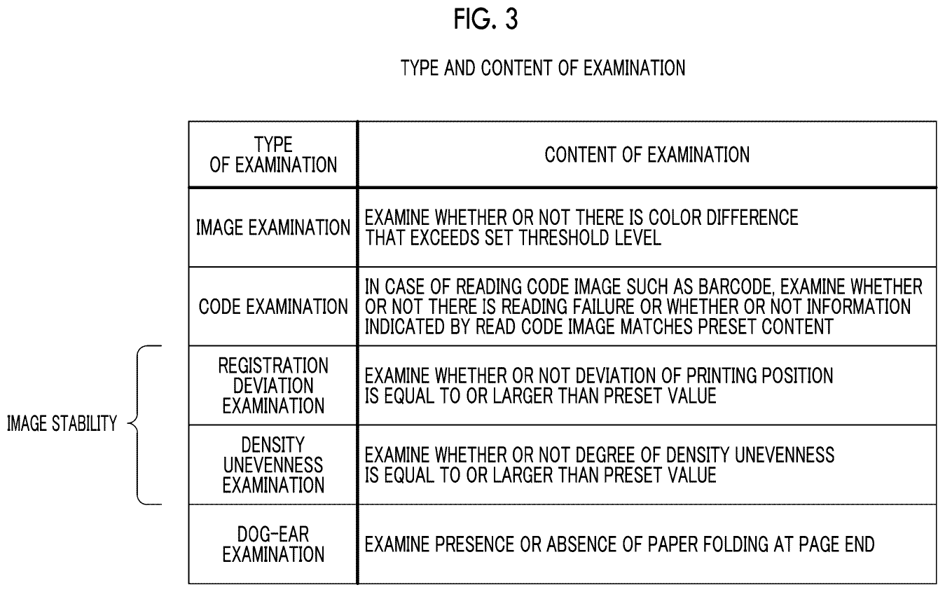

Here, there are various types of examinations to be performed by the examination device 30. FIG. 3 illustrates types and the content of examinations to be performed by the examination device 30.

Referring to FIG. 3, it can be seen that, in the examination device 30, five types of examinations, that is, an image examination, a code examination, an examination of a deviation of registration (hereinafter, referred to as a registration deviation examination), a density unevenness examination, and a dog-ear examination are performed.

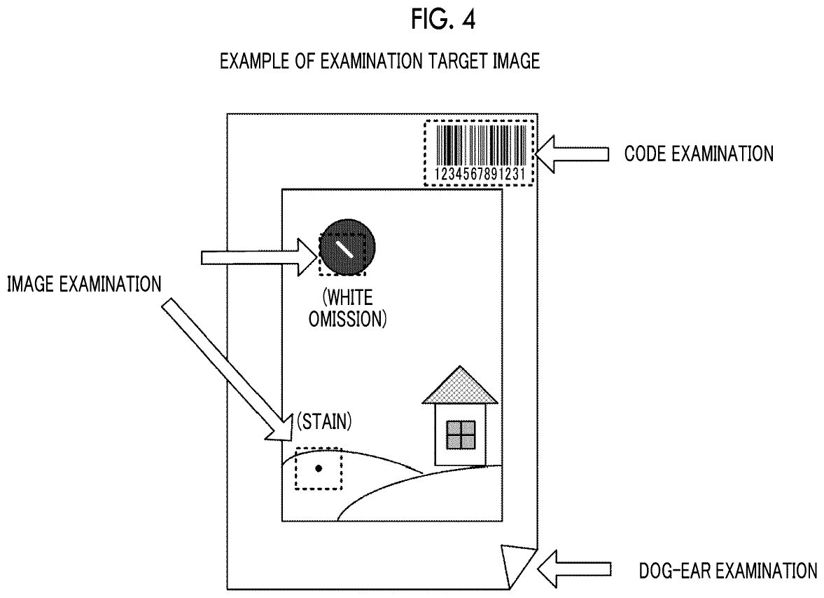

In addition, FIG. 4 illustrates an example of an examination target image on which various examinations are to be performed. FIG. 4 illustrates an example of a case where a code examination, an image examination, and a dog-ear examination are performed.

The image examination is an examination of checking the presence or absence of a printing defect such as a printing stain. For example, in the image examination, a stain, a white omission, or the like in the image example illustrated in FIG. 4 is detected as a printing defect. In this image examination, the image data of the image printed on the paper is used as a reference image, an image obtained by scanning the image on the paper after printing is compared with the reference image, and the presence or absence of a printing defect such as a printing stain is detected by detecting a color difference between the scanned image and the reference image. In a case where a threshold value is set for the color difference, it is determined that there is a printing defect in a case where the color difference equal to or larger than the threshold value is detected.

In addition, the code examination is an examination of reading a code image such as a barcode or a QR code (registered trademark) and determining whether or not information indicated by the code image matches the preset content. In this code examination, an examination error occurs in both a case where the code image cannot be read and a case where a result of reading is different from the content assumed in advance. The code examination includes processing of reading a text included in the printed image with an optical character reader (OCR) and determining whether or not the read text matches preset content.

In addition, in the registration deviation examination, whether or not a positional relationship between the printed image and the printing paper is deviated is examined. Specifically, in the registration deviation examination, whether or not a deviation of the printing position is equal to or larger than a preset value is examined. In addition, in the density unevenness examination, whether or not a degree of density unevenness in the printed image is equal to or larger than a preset value is examined. In addition, an image stability examination is realized by both examinations of the registration deviation examination and the density unevenness examination. In addition, in the dog-ear examination, the presence or absence of paper folding at a page end of the printing paper is examined.

Further, in the image forming system 10 according to the present exemplary embodiment, in a case where an error is detected in various types of examinations as described above, error correspondence processing for corresponding to the detected error is preset.

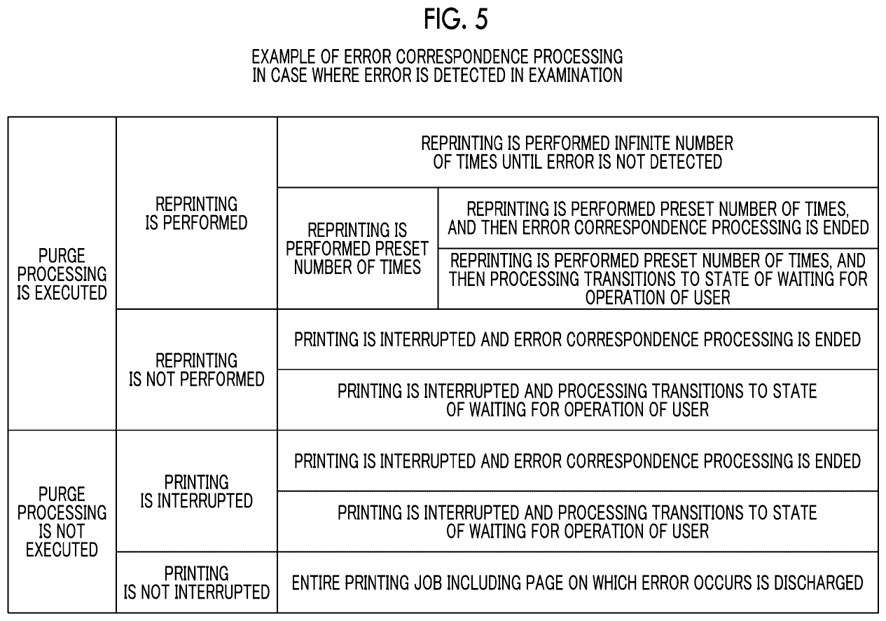

FIG. 5 illustrates a specific example of the error correspondence processing. Referring to FIG. 5, the correspondence processing for corresponding to the detected error is largely divided into two types of processing depending on whether or not the purge processing as described above is executed. Further, in a case where the purge processing is executed, the processing is largely divided into two types of processing depending on whether or not reprinting is performed.

In addition, in a case where reprinting is performed, there are a case where reprinting is performed an infinite number of times until an error is not detected and a case where reprinting is performed a preset number of times such as once or five times.

Further, in a case where reprinting is performed a preset number of times, there are a case where the reprinting is performed a preset number of times and then the error correspondence processing is ended and a case where the reprinting is performed a preset number of times and then the processing transitions to a state of waiting for an operation of a user.

Note that, in a case where the purge processing is not executed, there are a case where printing is interrupted and a case where printing is not interrupted. In a case where printing is interrupted, there are a case where the printing is interrupted and the error correspondence processing is ended and a case where the printing is interrupted and the processing transitions to a state of waiting for an operation of the user. In addition, in a case where printing is not interrupted, error correspondence processing of discharging the entire printing job including a page on which the error occurs is executed.

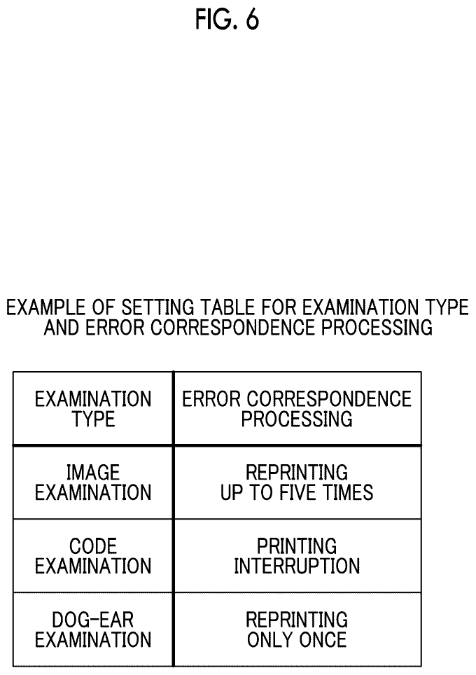

As described above, there are a plurality of types of examinations in a case where the printing result is examined, and there are a plurality of types of error correspondence processing in a case where an error is detected in the examination. Thus, it is necessary to associate each of the types of the examinations with the correspondence processing to be executed in a case where an error is detected. For example, in a state where a correspondence relationship between the examination type and the error correspondence processing as illustrated in FIG. 6 is set as a table, in a case where an error occurs in any of the plurality of types of examinations, it is possible to execute the correspondence processing for corresponding to the occurred error.

In the setting table illustrated in FIG. 6, it can be seen that the error correspondence processing of “reprinting up to five times” is set for the examination type of the image examination, that the error correspondence processing of “printing interruption” is set for the examination type of the code examination, and that the error correspondence processing of “reprinting only once” is set for the examination type of the dog-ear examination.

By associating the examination type with the error correspondence processing in advance in this way, in a case where only one type of error is detected from a printed material of one page, the error correspondence processing for dealing with the detected error can be determined. On the other hand, in a case where a plurality of different types of errors are detected from a printed material of one page, pieces of the error correspondence processing for dealing with the detected errors cannot be determined.

Therefore, in the image forming system 10 according to the present exemplary embodiment, even in a case where a plurality of different types of errors are detected from a printed material of one page, pieces of the error correspondence processing for dealing with the detected errors may be determined by the following method.

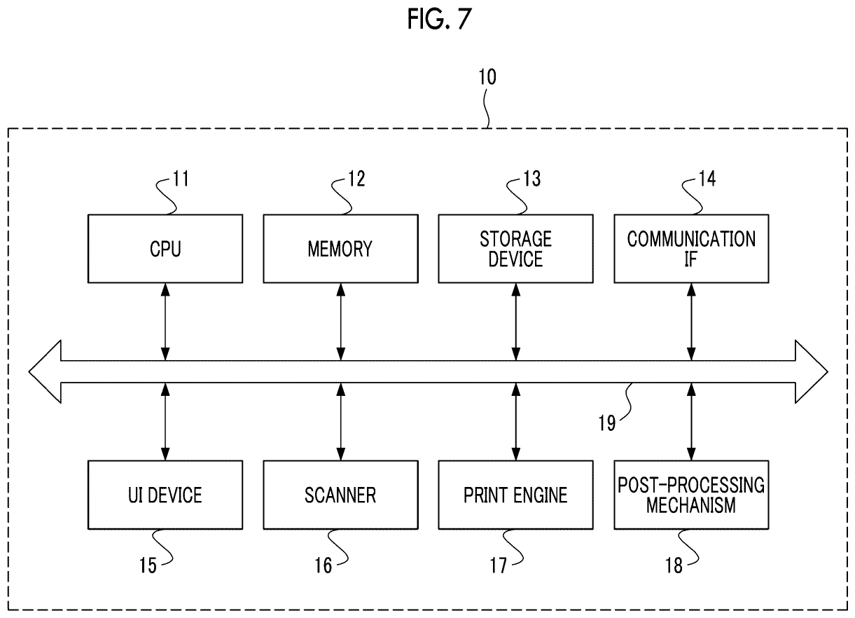

Next, a hardware configuration of the image forming system 10 according to the present exemplary embodiment is illustrated in FIG. 7. Note that, in FIG. 7, for simplification of the description, the image forming system 10 is described as having a hardware configuration in which only one CPU is provided. On the other hand, each of the printing device 20, the examination device 30, and the post-processing device 40 may have the hardware configuration illustrated in FIG. 7.

As illustrated in FIG. 7, the image forming system 10 includes a CPU 11, a memory 12, a storage device 13 such as a hard disk drive, a communication interface (abbreviated as IF) 14 that transmits and receives data to and from an external device or the like via a network, a user interface (abbreviated as UI) device 15 that includes a touch panel or a liquid crystal display and a keyboard, a scanner 16, a print engine 17, and a post-processing mechanism 18. These components are connected to each other via a control bus 19.

The print engine 17 prints an image on a recording medium such as printing paper through steps such as charging, exposure, development, transfer, and fixing. The recording medium may be any material, including paper, film, and the like, on which an image can be printed.

The CPU 11 is a processor that controls an operation of the image forming system 10 by executing predetermined processing based on a control program stored in the memory 12 or the storage device 13. Note that, in the present exemplary embodiment, the CPU 11 reads the control program stored in the memory 12 or the storage device 13 and executes the control program. On the other hand, the present disclosure is not limited thereto. The control program may be provided in a form of being recorded on a computer readable recording medium. For example, the program may be provided in a form of being recorded on an optical disk such as a compact disc (CD)-ROM and a digital versatile disc (DVD)-ROM, or in a form of being recorded on a semiconductor memory such as a Universal Serial Bus (USB) memory and a memory card. In addition, the control program may be acquired from an external device via a communication line connected to the communication interface 14. Further, the control program may be provided, for example, as single application software, or may be incorporated into software of each device of the image forming system 10 as one function.

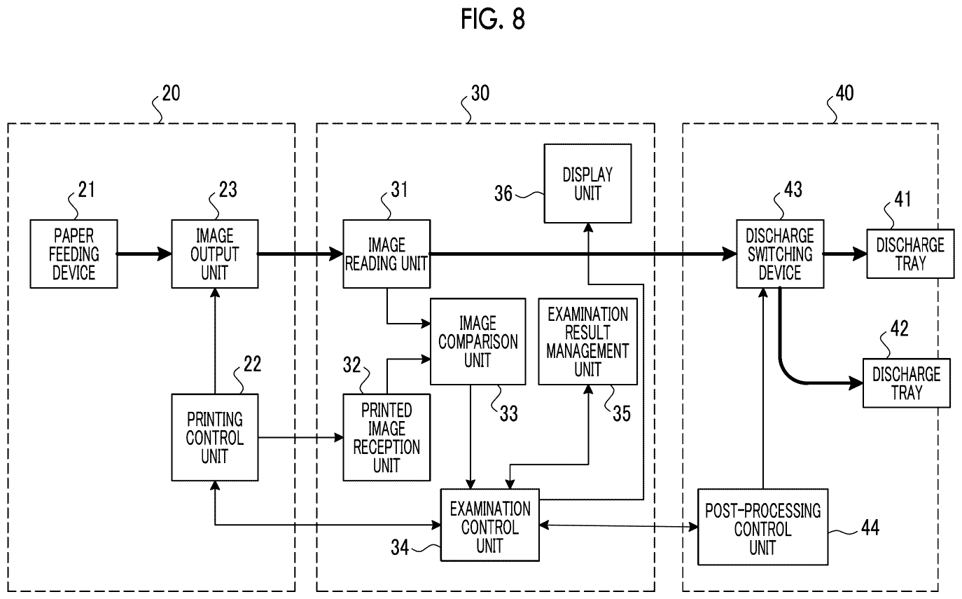

FIG. 8 is a block diagram illustrating a functional configuration of the image forming system 10 implemented by executing the control program.

In the image forming system 10 according to the present exemplary embodiment, as illustrated in FIG. 8, the printing device 20 includes a paper feeding device 21, an image output unit 23, and a printing control unit 22. In addition, the examination device 30 includes an image reading unit 31, a printed image reception unit 32, an image comparison unit 33, an examination control unit 34, an examination result management unit 35, and a display unit 36. Further, the post-processing device 40 includes discharge trays 41 and 42, a discharge switching device 43, and a post-processing control unit 44.

The paper feeding device 21 accommodates paper before an image is formed, and feeds the paper to the image output unit 23. The image output unit 23 prints an image on the paper that is fed from the paper feeding device 21.

The printing control unit 22 controls an operation of the image output unit 23 to execute processing of printing an image on the paper. Note that the printing control unit 22 transmits information of the printed image that is printed on the paper to the examination control unit 34 of the examination device 30.

The image reading unit 31 of the examination device 30 reads the image from the paper on which the image is printed by the image output unit 23. The printed image reception unit 32 receives the printed image that is transmitted from the printing control unit 22, as a reference image.

The image comparison unit 33 compares the scan image that is read by the image reading unit 31 with the reference image, which is the printed image received by the printed image reception unit 32, to determine whether or not there is an abnormality such as a printing defect in the image printed on the paper. Specifically, the image comparison unit 33 compares the scan image with the reference image to detect various abnormalities such as a printing stain, a printing blur, and a toner abnormality on the printed paper. Note that the image comparison unit 33 may use one of the images read by the image reading unit 31 as the reference image and compare the reference image with the other scan images.

The examination control unit 34 controls an operation of the examination device 30, and receives a detection result from the image comparison unit 33. The examination control unit 34 performs an examination on the printed image by determining whether or not the detected abnormality exceeds an examination threshold value that is preset. The examination result management unit 35 stores and manages the examination result obtained by the examination control unit 34.

In addition, the examination control unit 34 transmits the examination result to the printing control unit 25 and the post-processing control unit 44. Specifically, the examination control unit 34 transmits, to the printing control unit 22, information indicating which page should be reprinted, together with information indicating which page is determined as a page including a printing defect. In addition, the examination control unit 34 transmits, to the post-processing control unit 44, information of the purge page, which is information of a page to be discarded before reprinting is executed, together with information indicating which page is determined as a page including a printing defect.

The discharge switching device 43 of the post-processing device 40 switches the discharge destination of the paper, which is transported from the examination device 30, to any of the discharge trays 41 and 42. The post-processing control unit 44 controls an operation of the post-processing device 40, and performs control of instructing the discharge switching device 43 to switch the discharge destination to any of the discharge trays 41 and 42 based on the information of the purge page or the like that is transmitted from the examination control unit 34.

In addition, the printing control unit 22, the examination control unit 34, and the post-processing control unit 44 are operated in cooperation with each other by transmitting and receiving information to and from each other. Thereby, the entire operation of the image forming system 10 is controlled.

In the post-processing device 40 configured as described above, control is performed such that the paper determined as a normal page by the examination device 30 is discharged to the discharge tray 41 and the paper determined as a page including a printing defect and the paper for the purge page are discharged to the discharge tray 42.

The examination control unit 34 examines whether or not there is an error (abnormality) in the printed material on which printing is performed by the printing device 20. In addition, in a case where only a first error is detected from the printed material, the examination control unit 34 executes first error correspondence processing associated with the first error. In addition, in a case where only a second error, which is an error having a type different from the type of the first error, is detected from the printed material, the examination control unit 34 executes second error correspondence processing associated with the second error. Further, in a case where both the first error and the second error are detected from the printed material, the examination control unit 34 executes third error correspondence processing.

In addition, in the present exemplary embodiment, a priority is set for each of the types of the examinations. Further, the priority is set for each of the different types of the examinations, and thus, a priority is also set for the error detected in each examination.

In a case where the priority which is set for the first error is higher than the priority which is set for the second error, the examination control unit 34 executes the first error correspondence processing as third error correspondence processing.

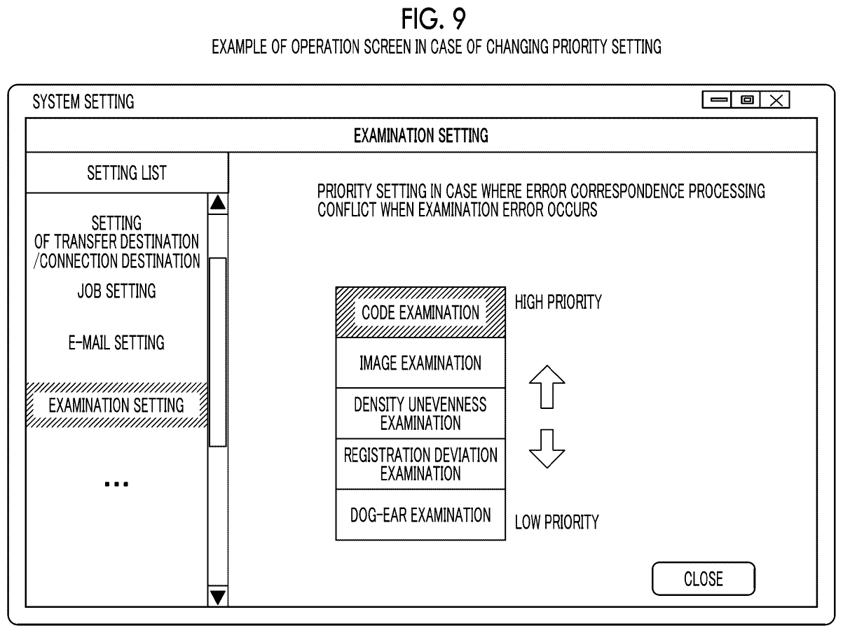

In the priority setting of setting the priority for each of the types of the examinations in this way, an initial priority may be set in advance for each of the types of the examinations. For example, in the code examination, in a case where the code image cannot be read or a code image having incorrect content is detected, it is necessary to immediately interrupt the execution of the print job and perform certain correspondence processing. Therefore, a high priority is set for the code examination. On the other hand, the priority setting may be freely changed by the user according to the use of the printed material and the like. FIG. 9 illustrates an example of an operation screen in a case of changing the priority setting.

In the operation screen example of FIG. 9, the type of the examination is selected, and the order of the priorities is changed by operating an up button or a down button. Thereby, the setting of the priority can be changed. FIG. 9 illustrates a state where “code examination” is selected, and the priority of “code examination” can be lowered by operating the down button.

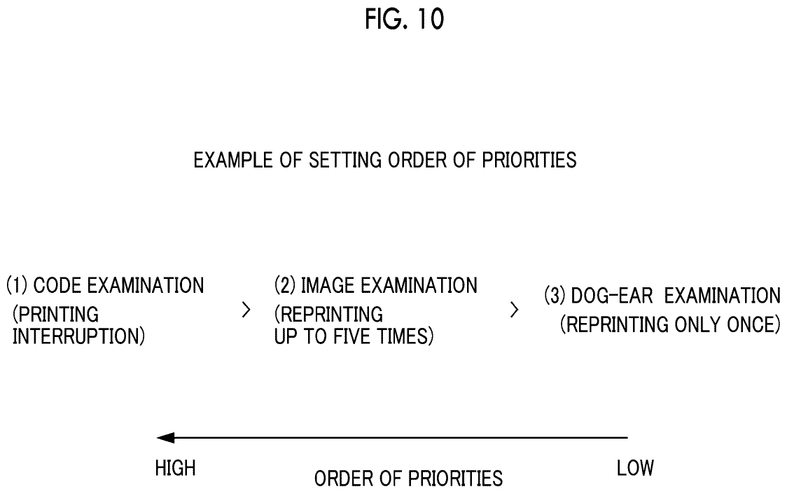

FIG. 10 illustrates an example of a case where the order of the priorities for the types of the examinations is set by setting the priority for each of the plurality of types of the examinations in this way.

FIG. 10 illustrates a setting example in a case where a highest priority is set for the code examination, where a priority lower than the priority of the code examination is set for the image examination, and where a lowest priority is set for the dog-ear examination. That is, the priorities are set in order of (1) code examination, (2) image examination, and (3) dog-ear examination.

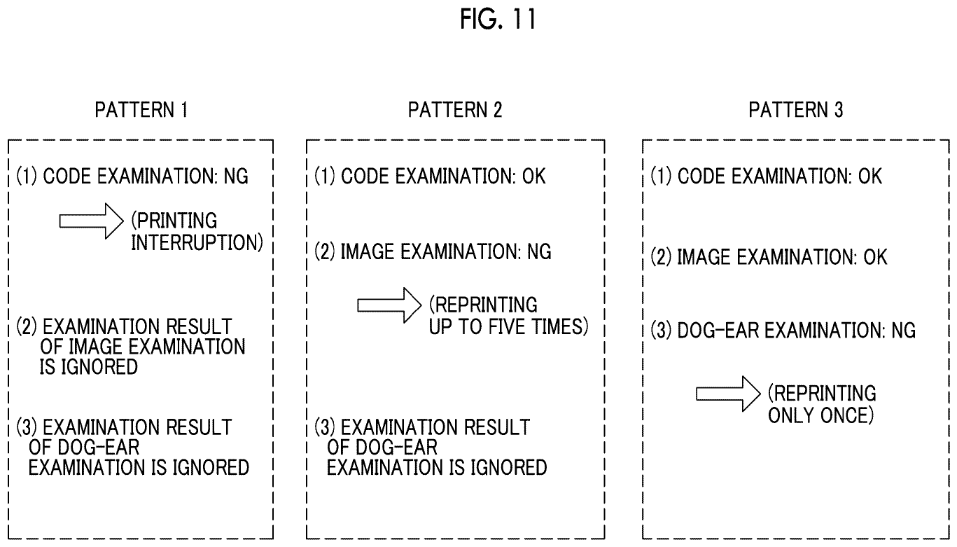

In a state where the order of the priorities is set, FIG. 11 illustrates a pattern of a method of determining the error correspondence processing in a case where a plurality of different types of examinations are executed on the examination target image as illustrated in FIG. 4.

In a pattern 1 among the patterns illustrated in FIG. 11, an error is detected in the code examination having the highest priority. Therefore, the examination control unit 34 selects print interruption processing associated with the code examination, as the error correspondence processing to be executed. In this case, the examination result of the image examination and the examination result of the dog-ear examination are ignored.

In a pattern 2 among the patterns illustrated in FIG. 11, an error is not detected in the code examination having the highest priority, and an error is detected in the image examination having the second highest priority. Therefore, the examination control unit 34 selects reprinting processing up to five times that is associated with the image examination, as the error correspondence processing to be executed. In this case, the examination result of the dog-ear examination is ignored.

In a pattern 3 among the patterns illustrated in FIG. 11, an error is not detected in the code examination having the highest priority or the image examination having the second highest priority, and an error is detected in the dog-ear examination having the lowest priority. Therefore, the examination control unit 34 selects processing of reprinting only once, which is associated with the dog-ear examination, as the error correspondence processing to be executed.

By setting the priorities for each of the types of the examinations in this way, in a case where an error in a printed material of one page is detected, the error correspondence processing associated with the examination having the highest priority, among the types of the examinations in which the error is detected, is executed.

On the other hand, in a case where a plurality of different types of errors are detected from a printed material of one page, there may be a correlation relationship between the plurality of detected errors. Specifically, in a state where a plurality of different types of errors are detected from a printed material of one page, in a case where a region in which an error is detected in one examination and a region in which an error is detected in another examination overlap with each other, there may be a correlation relationship between the plurality of detected errors.

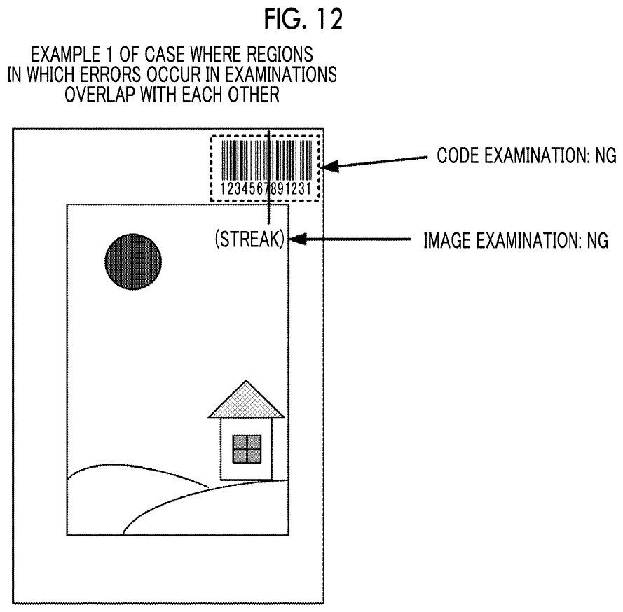

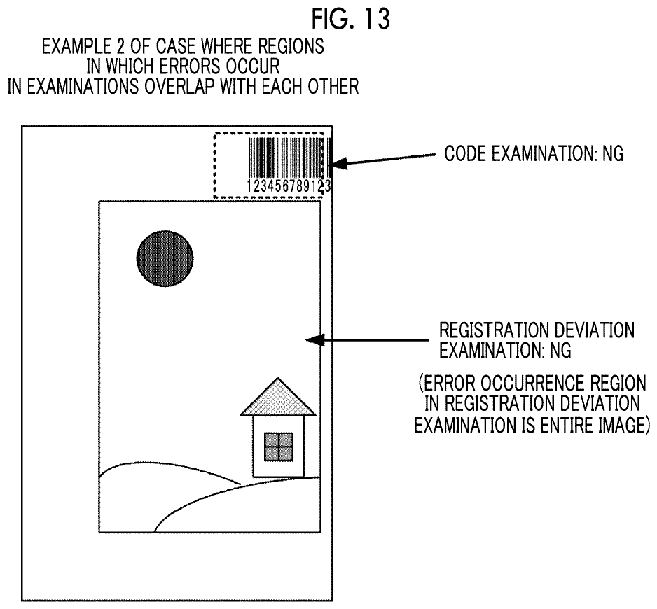

FIG. 12 and FIG. 13 illustrate an example of a case where regions in which a plurality of errors occur in the examinations overlap with each other.

In the example illustrated in FIG. 12, a streak occurs on the code image, an error is detected in the code examination, and an error is detected in the image examination by detecting the streak in the printing region of the code image.

In such a case, it is considered that there is an error in the code examination because the streak is printed on the code image due to some kind of problem. Therefore, in a case where the streak is removed by executing reprinting, there is a high possibility that the error in the code examination and the error in the image examination are eliminated.

In the example illustrated in FIG. 13, a case where an error is detected in the registration deviation examination due to a deviation of the printing position of the entire printed image and an error occurs in the code examination due to a deviation of the printing position of the code image is illustrated.

For the deviation of the printing position, in a case where reprinting is performed, there is a high probability that normal printing is performed.

In addition, in a case where the deviation of the printing position is eliminated, there is a high possibility that the error in the code examination and the error in the registration deviation examination are eliminated. Note that, in a case where an error is detected in the registration deviation examination, the error occurrence region is the entire page since the entire page is not an expected result, and in a case where an error occurs in other types of examinations, the error occurrence regions overlap with each other.

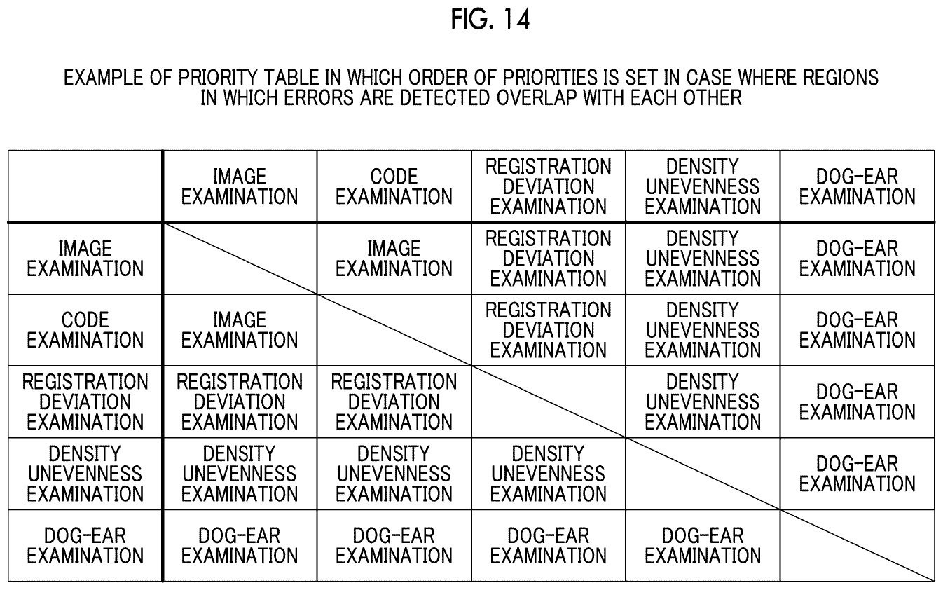

In addition, in a case where errors are detected in a plurality of types of examinations as described above and the regions in which the errors are detected overlap with each other, the examination control unit 34 determines the error correspondence processing based on the priority which is set in the priority table as illustrated in FIG. 14, instead of the priority which is preset.

FIG. 14 is an example of a priority table in which the order of the priorities is set in a case where the regions in which the errors are detected overlap with each other. For example, in a case where a region in which an error is detected in the image examination and a region in which an error is detected in the code examination overlap with each other, the error correspondence processing associated with the image examination is selected. In addition, in a case where a region in which an error is detected in the image examination and a region in which an error is detected in the dog-ear examination overlap with each other, the error correspondence processing associated with the dog-ear examination is selected.

By performing determination in this way, in a case where the priority which is set for the first error is higher than the priority which is set for the second error and the region in which the first error is detected and the region in which the second error is detected do not overlap with each other, the examination control unit 34 executes the first error correspondence processing associated with the first error, as the third error correspondence processing. On the other hand, in the priority table as illustrated in FIG. 14, in a case where the priority which is set for the second error is higher than the priority which is set for the first error, the examination control unit 34 executes the second error correspondence processing as the third error correspondence processing in a case where the region in which the first error is detected and the region in which the second error is detected overlap with each other.

Note that, in a case where both the first error and the second error in different types of examinations are detected from a printed material of one page, the examination control unit 34 may execute, as the third error correspondence processing, processing different from both the first error correspondence processing associated with the first error and the second error correspondence processing associated with the second error.

In this case, the examination control unit 34 stores, as the third error correspondence processing, the error correspondence processing that is received in advance by the selection of the user, and executes the stored third error correspondence processing in a case where both the first error and the second error are detected from the printed material of one page.

For example, in a state where error correspondence processing of print interruption is associated with the code examination and error correspondence processing of reprinting only once is associated with the dog-ear examination, in a case where errors are detected in the code examination and the image examination from the printed material of one page and the error occurrence regions overlap with each other, the examination control unit 34 executes processing of printing interruption and transitioning to a state of waiting for an operation of the user, as the error correspondence processing.

Note that, in the above description, a case where the priority is set in association with the type of the examination, that is, the type of the error has been described. On the other hand, the priority may be set for each type of the error correspondence processing. For example, by setting the priority of the error correspondence processing of printing interruption to be higher than the priority of the error correspondence processing of reprinting, it is possible to always execute the error correspondence processing of printing interruption with a higher priority even in a case where errors occur in a plurality of different types of examinations from the printed material of one page.

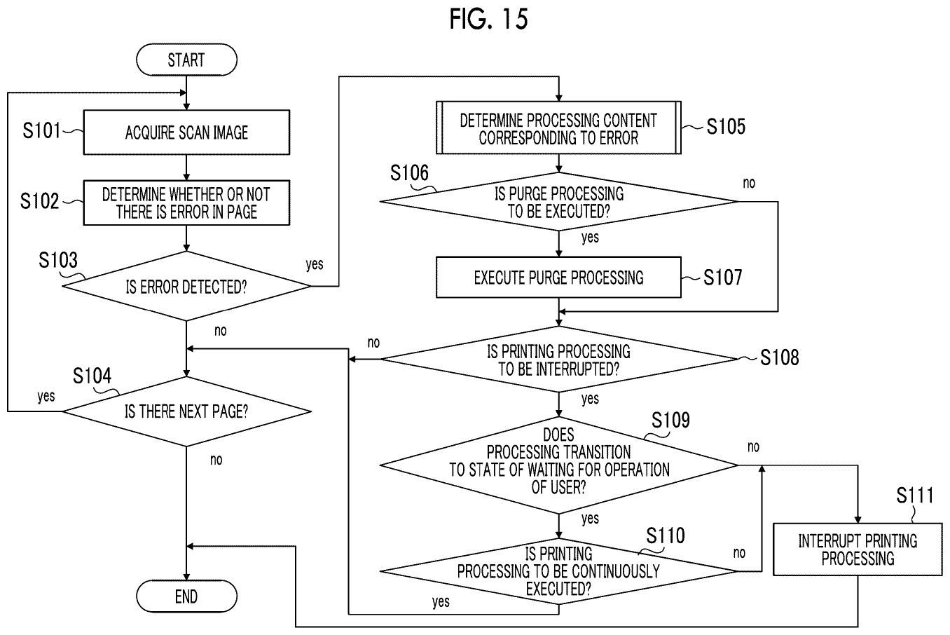

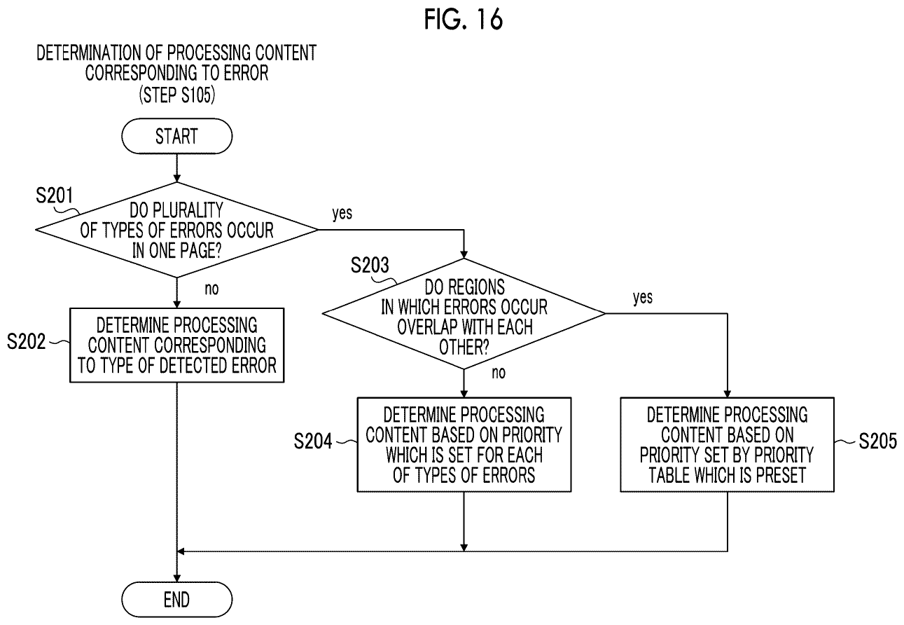

Next, an operation of the image forming system 10 according to the present exemplary embodiment will be described with reference to flowcharts of FIG. 15 and FIG. 16.

First, in step S101, the image reading unit 31 acquires a scan image from the printed material. In addition, in step S102, the image comparison unit 33 compares the scan image acquired by the image reading unit 31 with the reference image received by the printed image reception unit 32 to determine whether or not there is an error in the page. Further, in step S103, the examination control unit 34 determines whether or not an error is detected in the image examination from the comparison result of the image comparison unit 33. Note that the examination control unit 34 executes not only the image examination by comparing the scan image with the reference image but also the code examination, the dog-ear examination, the density unevenness examination, and the registration deviation examination as described above and determines whether or not an error is detected.

In a case where it is determined in step S103 that an error is not detected in any of the examinations, in step S104, the examination control unit 34 determines whether or not there is a next page. In step S104, in a case where it is determined that there is no next page, the examination control unit 34 ends the examination. In addition, in a case where it is determined in step 104 that there is a next page, the examination control unit 34 returns to the processing of step S101.

In addition, in a case where an error is detected in any examination in step S103, in step S105, the examination control unit 34 determines the processing content of the error correspondence processing for corresponding to the detected error.

Further, in step S106, the examination control unit 34 determines whether or not the determined processing content of the error correspondence processing includes an execution of purge processing. In a case where it is determined in step S106 that the determined processing content of the error correspondence processing includes an execution of purge processing, in step S107, the examination control unit 34 executes the purge processing.

In addition, in a case where it is determined in step S106 that the determined processing content of the error correspondence processing does not include an execution of purge processing, in step S108, the examination control unit 34 determines whether or not the determined processing content of the error correspondence processing includes interruption of the printing processing.

In a case where it is determined in step S108 that the determined processing content of the error correspondence processing does not include interruption of the printing processing, the examination control unit 34 returns to processing of step S104. In addition, in a case where it is determined in step S108 that the determined processing content of the error correspondence processing includes interruption of the printing processing, in step S109, the examination control unit 34 determines whether or not the determined processing content of the error correspondence processing includes a transition to a state of waiting for an operation of the user.

In a case where it is determined in step S109 that the determined processing content of the error correspondence processing includes a transition to a state of waiting for an operation of the user, in step S110, the examination control unit 34 determines whether or not the printing processing is to be executed.

In a case where it is determined in step S110 that the printing processing is to be executed, the examination control unit 34 returns to the processing of step S104.

In addition, in a case where it is determined in step S109 that the determined processing content of the error correspondence processing does not include a transition to a state of waiting for an operation of the user, and in a case where it is determined in step S110 that the printing processing is not to be executed, in step S111, the examination control unit 34 interrupts the printing processing and ends the processing.

Next, details of the processing of step S105 described with reference to the flowchart in FIG. 15 will be described with reference to a flowchart in FIG. 16.

First, in step S201, the examination control unit 34 determines whether or not a plurality of types of errors occur in one page. In a case where it is determined in step S201 that a plurality of types of errors do not occur in one page, in step S202, the examination control unit 34 determines the processing content corresponding to the type of the detected error, as the error correspondence processing.

Note that, in a case where an error does not occur in any of the examinations, the examination control unit 34 does not set the error correspondence processing.

In a case where it is determined in step S201 that a plurality of types of errors occur in one page, in step S203, the examination control unit 34 determines whether or not the regions in which the errors occur overlap with each other.

In a case where it is determined in step S203 that the regions in which the errors occur do not overlap with each other, in step S204, the examination control unit 34 determines the processing content of the error correspondence processing based on the priority which is set for each of the types of the errors. Specifically, the examination control unit 34 determines the processing content associated with the examination type for which the highest priority is set, among the plurality of types of the examinations in which the errors occur, as the error correspondence processing.

In addition, in a case where it is determined in step S203 that the regions in which the errors occur overlap with each other, in step S205, the examination control unit 34 determines the processing content of the error correspondence processing based on the priority that is set by the priority table which is preset. Specifically, the examination control unit 34 determines the processing content of the error correspondence processing based on the priority which is set by the priority table as illustrated in FIG. 14.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The term “system” in the present exemplary embodiment includes both a system configured by a plurality of devices and a system configured by a single device.

### Modification Example

In the above-described exemplary embodiment, a case where the present disclosure is applied to the image forming system 10 including the printing device 20 has been described. On the other hand, the present disclosure is not limited thereto. The present disclosure can be applied to a configuration in which an information processing system such as a personal computer performs the examination on the printed material as described above.

### APPENDIX

Hereinafter, aspects of the present disclosure will be additionally described.

(((1)

An information processing system comprising:
a processor configured to:
   examine whether or not there is an abnormality in a printed material;
   execute first processing associated with a first abnormality in a case where only the first abnormality is detected from the printed material;
   execute second processing associated with a second abnormality having a type different from a type of the first abnormality in a case where only the second abnormality is detected from the printed material; and
   execute third processing in a case where both the first abnormality and the second abnormality are detected from the printed material.
      (((2)))

The information processing system according to (((1))), wherein the processor is configured to:
execute the first processing as the third processing in a case where a priority which is set for the first abnormality is higher than a priority which is set for the second abnormality.
   (((3)))

The information processing system according to (((2))), wherein the processor is configured to:
in a case where the priority which is set for the first abnormality is higher than the priority which is set for the second abnormality, execute the first processing as the third processing in a case where a region in which the first abnormality is detected and a region in which the second abnormality is detected do not overlap with each other, and execute the second processing as the third processing in a case where a region in which the first abnormality is detected and a region in which the second abnormality is detected overlap with each other.
   (((4)))

The information processing system according to (((1))), wherein the processor is configured to:
in a case where both the first abnormality and the second abnormality are detected from the printed material, execute processing different from both the first processing and the second processing, as the third processing.
   (((5)))

The information processing system according to (((4))), wherein the processor is configured to:
execute processing received in advance by selection of a user, as the third processing.
   (((6)))

A program causing a computer to execute a process comprising:
examining whether or not there is an abnormality in a printed material;
executing first processing associated with a first abnormality in a case where only the first abnormality is detected from the printed material;
executing second processing associated with a second abnormality in a case where only the second abnormality having a type different from a type of the first abnormality is detected from the printed material; and
executing third processing in a case where both the first abnormality and the second abnormality are detected from the printed material.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a processor configured to:
examine whether or not there is an abnormality in a printed material;
execute first processing associated with a first abnormality in a case where only the first abnormality is detected from the printed material;
execute second processing associated with a second abnormality having a type different from a type of the first abnormality in a case where only the second abnormality is detected from the printed material; and
execute third processing in a case where both the first abnormality and the second abnormality are detected from the printed material.

2. The information processing system according to claim 1, wherein the processor is configured to:
execute the first processing as the third processing in a case where a priority which is set for the first abnormality is higher than a priority which is set for the second abnormality.

3. The information processing system according to claim 2, wherein the processor is configured to:
in a case where the priority which is set for the first abnormality is higher than the priority which is set for the second abnormality, execute the first processing as the third processing in a case where a region in which the first abnormality is detected and a region in which the second abnormality is detected do not overlap with each other, and execute the second processing as the third processing in a case where a region in which the first abnormality is detected and a region in which the second abnormality is detected overlap with each other.

4. The information processing system according to claim 1, wherein the processor is configured to:
in a case where both the first abnormality and the second abnormality are detected from the printed material, execute processing different from both the first processing and the second processing, as the third processing.

5. The information processing system according to claim 4, wherein the processor is configured to:
execute processing received in advance by selection of a user, as the third processing.

6. A non-transitory computer readable medium storing a program causing a computer to execute a process comprising:
examining whether or not there is an abnormality in a printed material;
executing first processing associated with a first abnormality in a case where only the first abnormality is detected from the printed material;
executing second processing associated with a second abnormality in a case where only the second abnormality having a type different from a type of the first abnormality is detected from the printed material; and
executing third processing in a case where both the first abnormality and the second abnormality are detected from the printed material.

7. An information processing method comprising:
examining whether or not there is an abnormality in a printed material;
executing first processing associated with a first abnormality in a case where only the first abnormality is detected from the printed material;
executing second processing associated with a second abnormality in a case where only the second abnormality having a type different from a type of the first abnormality is detected from the printed material; and
executing third processing in a case where both the first abnormality and the second abnormality are detected from the printed material.
